(19) United States
(12) Patent Application Publication
(10) Pub. No.: US 2012/0041615 A1
(43) Pub. Date: Feb. 16, 2012

(54) FAN SPEED CONTROL SYSTEM

(75) Inventor: YAO-TING CHANG, Tu-Cheng (TW)

(73) Assignee: HON HAI PRECISION INDUSTRY CO., LTD., Tu-Cheng (TW)

(21) Appl. No.: 12/862,699

(22) Filed: Aug. 24, 2010

(30) Foreign Application Priority Data
Aug. 12, 2010 (TW) 99126956

(51) Int. Cl. G05D 23/19; G06F 9/24

(52) U.S. Cl. 700/300; 713/2

(57) ABSTRACT

A fan speed control system includes a fan, a hardware device, a switch code module, and a basic input/output system (BIOS) module. The switch code module is operable to set a switch code. The BIOS module includes a memory unit, a switch code detecting unit, a searching unit, and a control unit. The memory unit stores a matching table of different switch codes and corresponding fan speed control curves. The switch code detecting unit is operable to detect the switch code set by the switch code module. The searching unit is operable to read the matching table and search which fan speed control curve matches with the switch code set by the switch code module. The control unit is operable to select the matched fan speed control curve to control the fan speed of the fan.

### CROSS-REFERENCE OF RELATED APPLICATIONS

Relevant subject matters are disclosed in two co-pending U.S. patent applications (Attorney Docket No. US34630, US34640), which are assigned to the same assignee as this patent application.

### BACKGROUND

1. Technical Field

The present disclosure relates to a fan speed control system.

2. Description of Related Art

In a computer system, one or more fans may be installed in the computer system to dissipate heat of generated by hardware devices, such as a hard disk drive (HDD). The fan speed of a fan is controlled by some fan speed control curves set in software under different conditions.

Referring to FIG. 1, the figure shows two fan speed control curves A and B. At the same temperature, the fan speed controlled by the curve A is greater than the fan speed controlled by the curve B. In other words, the curve A is used to control the fan to dissipate heat of a high powered hardware device, and the curve B is used to control the fan to dissipate heat of a low powered hardware device, which can save electricity. Nowadays, a fan speed control system is to use a basic input/output system (BIOS) module to detect what the hardware device is, and correspondingly select an appropriate fan speed control curve for the hardware device. When the hardware device is new, the BIOS module cannot detect what it is, therefore the BIOS can only select the fan speed control curve which controls the fan at the highest rotations per minute (RPM) speed state to make sure the computer system will continue to work normally. However, the new hardware device may not need to use the fan speed control curve which controls the fan at the highest RPM speed state, and other fan speed control curves may be more appropriate for the new device in terms of electricity-saving.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is a waveform chart of two common fan speed control curves.

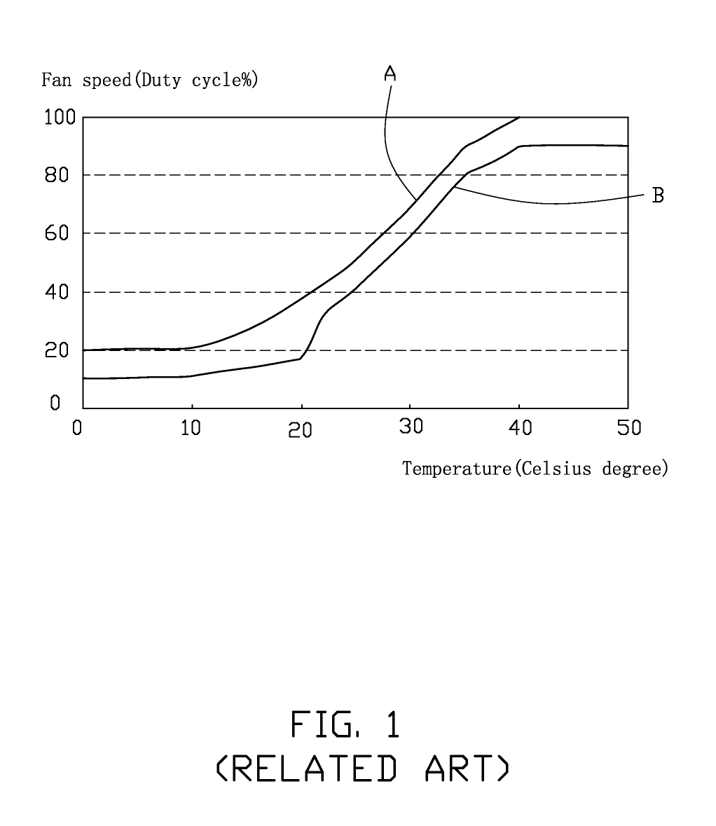

FIG. 2 is a block diagram of an embodiment of a fan speed control system including a switch code module.

FIG. 3 is a circuit diagram of the switch code module of FIG. 2.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

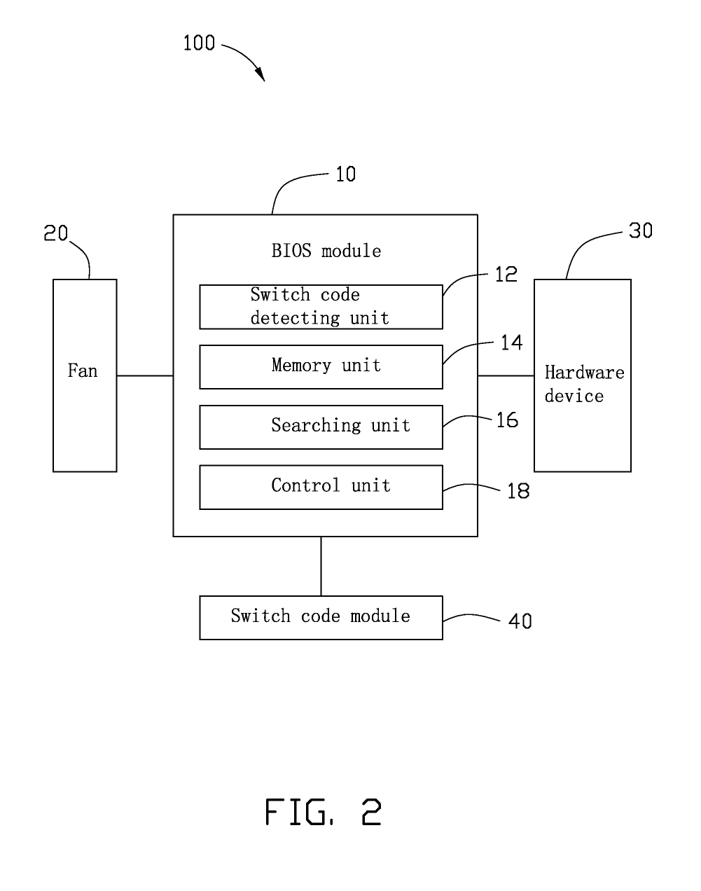

Referring to FIG. 2, an embodiment of a fan speed control system 100 includes a basic input/output system (BIOS) module 10, a fan 20, a hardware device 30, and a switch code module 40. The BIOS module 10 is used to initialize and identify system devices such as video display cards, keyboards, mice, hard disks, and other hardware devices when the computer system boots up. In other embodiments, the number of the fan 20 and the hardware device 30 may be more than one.

The BIOS module 10 includes a switch code detecting unit 12, a memory unit 14, a searching unit 16, and a control unit 18. The memory unit 14 stores a matching table of different switch codes and corresponding fan speed control curves, and each switch code corresponds to a fan speed control curve. The following table shows an example of the matching table layout.

| | 00 | 01 | 10 | . . . |
|---|---|---|---|---|
| Curve A | Y | N | N | . . . |
| Curve B | N | Y | N | . . . |
| Curve C | N | N | Y | . . . |
| . . . | . . . | . . . | . . . | . . . |

Where, each cell of the first row of the table shows a switch code, each cell of the first column of the table shows a fan speed control curve. “Y” means matching, and “N” means not matching. For example, the curve “A” matches with the switch code “00”. The matching table can be edited in the BIOS user interface. For example, if the computer system needs to use a new switch code and/or needs to use a new fan speed control curve, operators can add the new switch code and/or the new fan speed control curve in the matching table by the BIOS user interface.

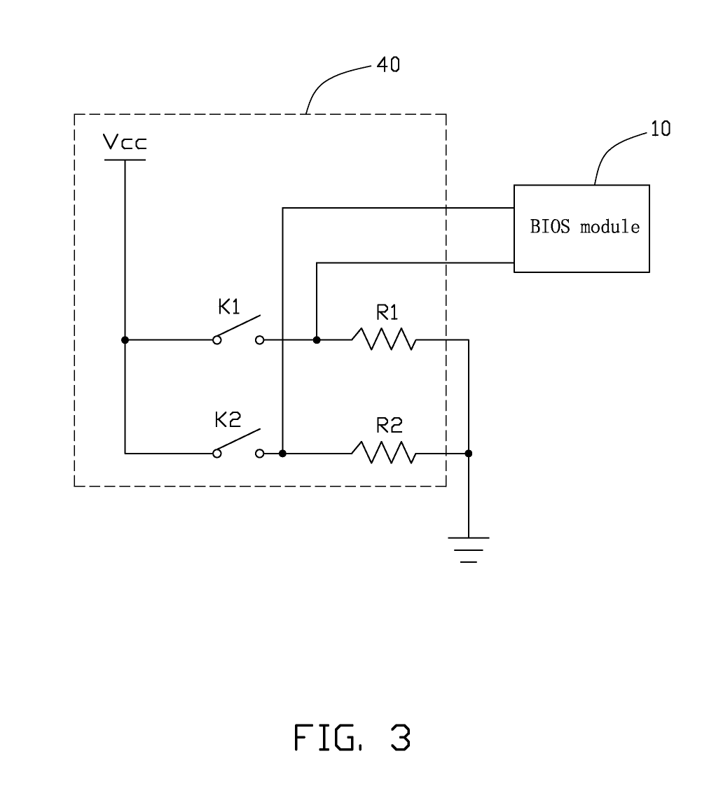

Referring to FIG. 3, the switch code module 40 includes a power supply Vcc, two switches K1 and K2, and two resistors R1 and R2. The switch K1 and the resistor R1 are connected in series between the power supply Vcc and ground. The switch K2 and the resistor R2 are connected in series between the power supply Vcc and ground. A node between the switch K1 and the resistor R1, and a node between the switch K2 and the resistor R2 are connected to the BIOS module 10. The switches K1 and K2 are used to set a switch code for the BIOS module 10. For example, when the switch K1 is turned on and the switch K2 is turned off, the switch code is “10”. In other embodiments, a third or more switches and corresponding resistors are connected in series between the power supply Vcc and ground, which can set more switch codes.

When the computer boots up, the switch code detecting unit 12 detects the switch code set by the switch code module 40. The searching unit 16 reads the matching table saved in the memory unit 14 and searches which fan speed control curve matches with the switch code set by the switch code module 40, and then transmits matching information to the control unit 18. The control unit 18 selects the matching fan speed control curve to control the fan speed of the fan 20 according to the matching information.

The fan speed control system 100 saves a matching table between different switch codes and different fan speed control curves, detects the switch code set by the switch code module 40, searches for an appropriate fan speed control curve by the searching unit 16, and then selects the matching fan speed control curve to control the fan speed of the fan 20 by the control unit 18, thereby the operator can select an appropriate fan speed control curve for the hardware device 30 by set an appropriate switch code by the switch code module 40, which can conserve electricity.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A fan speed control system comprising:
a fan;
a hardware device;
a switch code module operable to set a switch code; and
a basic input/output system (BIOS) module comprising:
a memory unit storing a matching table of different switch codes and different fan speed control curves, and each of the switch codes corresponding to one of the fan speed control curves;
a switch code detecting unit operable to detect the switch code set by the switch code module;
a searching unit operable to read the matching table and search which fan speed control curve matches with the switch code set by the switch code module; and
a control unit operable to select the matching fan speed control curve to control a speed of the fan.

2. The fan speed control system of claim 1, wherein the switch code module comprises a power supply, a plurality of switches, and a plurality of resistors, each of the plurality of switches is connected to one of the plurality of resistors in series between the power supply and ground, nodes between the plurality of switches and corresponding resistors are connected to the BIOS module.
